(19) United States
(12) Patent Application Publication
(10) Pub. No.: US 2012/0102840 A1
(43) Pub. Date: May 3, 2012

(54) SLIDING PARTITION FASTENERS

(75) Inventor: Su-Wen Chen, Portland, OR (US)

(73) Assignee: 3FORM, INC., Salt Lake City, UT (US)

(21) Appl. No.: 13/381,601

(22) PCT Filed: Jul. 6, 2010
(86) PCT No.: PCT/US10/41076

§ 371 Date: Dec. 29, 2011

Related U.S. Application Data
(60) Provisional application No. 61/223,632, filed on Jul. 7, 2009.

(51) Int. Cl. E06B 3/46; E05C 19/12

(52) U.S. Cl. 49/449; 292/96; 292/101

(57) ABSTRACT

A compact fastener configured to latch a sliding partition to a second structure can include an actuator configured to move a hook in and out of a locked position. In one or more implementations, compact fastener can further include a pin extending from the actuator into a slot in the hook. As the actuator rotates, the pin can slide along the groove causing the hook to rotate. Additionally, in one or more implementations, the actuator can rotate about a first axis, and the hook can rotate about a second axis offset from the first axis. The fastener can further include one or more of a latch handle and a lock configured to rotate the actuator. The lock can include a dowel pin that extends into a groove of the actuator.

### CROSS-REFERENCE TO RELATED APPLICATIONS

The present invention is a U.S. National Stage of PCT Patent Application No. PCT/US10/41076, filed on Jul. 6, 2010, which claims the benefit of priority to U.S. Provisional Application No. 61/223,632, filed Jul. 7, 2009, entitled “Sliding Door Fastener.” The entire content of each of the foregoing patent applications is incorporated by reference herein.

### BACKGROUND OF THE INVENTION

1. The Field of the Invention

This invention relates to apparatus, systems, and methods for fastening a sliding partition to another structure.

2. Background and Relevant Art

Some recent architectural designs are now implementing resin-based or glass panels as windows, doors, or other sliding partitions. For example, resin-based materials are now popular materials for sliding partitions; since resin materials can allow a designer to provide an environment with a wide variety of different aesthetic designs. For instance, resin-based panels can be transparent, translucent, opaque, or colored. Additionally, resin-based panels can include any number of decorative images layers, such as, for example, fabric, metallic wire, rod and/or bar, papers or printed or photographic images, crushed glass, and vegetation, such as wood chips, grasses, flowers, wheat, and thatch.

Such resin-based panels can include a substrate of one or more layers or sheets formed from any one of the following thermoplastic polymers (or alloys thereof). Specifically, such materials can include, but are not limited to, polyethylene terephthalate (PET), polyethylene terephthalate with glycol-modification (PETG), acrylonitrile butadiene-styrene (ABS), polyvinyl chloride (PVC), polyvinyl butyral (PVB), ethylene vinyl acetate (EVA), polycarbonate (PC), styrene, polymethyl methacrylate (PMMA), polyolefins (low and high density polyethylene, polypropylene), thermoplastic polyurethane (TPU), cellulose-based polymers (cellulose acetate, cellulose butyrate or cellulose propionate), or the like.

Designers implementing resin-based or glass panels as sliding partitions may desire to mount the panel in a way that allows the panel to display its aesthetic properties. For instance, designers may desire to reduce the size and visibility of mounting hardware, such as a frame, supporting the panel. Unfortunately, many conventional sliding door fasteners (i.e., latches and locks) are often too bulky or otherwise require the use of larger frames or mounting hardware.

For example, conventional door fasteners may be thicker than desired, and thereby, require the designer to use a thicker panel or to use support hardware. Along similar lines, conventional door fasteners may be wider than desired, and thereby, require extension into the edge of the panel or the use of wider supporting hardware. Such conventional sliding door fasteners may require modifications that are unsatisfactory to designers. For instance, the price of resin-based and glass panels are often proportional to the thickness, and thus, using thicker panels can increase the cost of the sliding partition. Furthermore, using supporting hardware that is much thicker or wider than the sliding panel, can adversely affect the aesthetics and/or structural integrity of the door.

Additionally, conventional door fasteners often are designed either as a latch (i.e., non locking fastener) or a lock (i.e., a locking fastener). Unfortunately, conventional latch fasteners and conventional lock fasteners often have different sizes or shapes. The different configurations of conventional latch and lock fasteners can require different sized or shaped supporting hardware. This difference in supporting hardware can prevent a designer from being able to switch conventional latch door-fasteners for conventional lock door-fasteners, or vice versa.

### BRIEF SUMMARY OF THE INVENTION

One or more implementations of the present invention solve one or more of the forgoing, or other, problems in the art with systems, methods, and apparatus for locking and latching sliding partitions to another structure that complement the aesthetic features of a mounted partition or set of panels. For example, one or more implementations provide compact sliding partition fasteners that can reduce the visibility of hardware by allowing the use of relatively small panel frames or other mounting hardware. In particular, one or more implementations provide compact sliding partition fasteners with a relatively small width and/or thickness.

For instance, one implementation of a sliding partition fastener can include a housing and an actuator. The actuator can be positioned at least partially within the housing. The actuator can be configured to rotate about a first axis. The sliding partition fastener can further include a hook coupled to the actuator. The hook can be configured to rotate about a second axis that is offset from the first axis. Furthermore, the rotation of the actuator about the first axis can cause the hook to rotate about the second axis between a released position and a locked position.

Additionally, another implementation of a sliding partition fastener can include a hook and an actuator coupled to the hook. The actuator can include a groove therein. The sliding partition fastener can also include a lock configured to receive a key and rotate about a first axis. In addition, the sliding partition fastener can include a dowel pin secured to the lock. The dowel pin can extend from the lock into the groove of the actuator. Furthermore, rotation of the lock about the first axis can cause the dowel pin to engage the groove of the actuator and rotate the actuator. Rotation of the actuator can cause the hook to move between a locked position and a released position.

In addition to the foregoing, a sliding partition can include a decorative architectural panel, and a casing secured to at least one edge of the decorative architectural panel. The sliding partition can also include a sliding partition fastener at least partially enclosed with the casing. The sliding partition fastener can be configured to latch the decorative architectural panel to another structure. The sliding partition fastener can include an actuator configured to be rotated by one or more of a latch handle and a lock. The sliding partition fastener can further include a hook coupled to the actuator. The hook can include a slot. The sliding partition fastener can additionally include a pin extending from the actuator into the slot of the hook. Furthermore, rotation of one or more of the latch handle and the lock can cause the pin to slide along the slot and rotate the hook in and out of a locked position.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. It should be noted that the figures are not drawn to scale, and that elements of similar structure or function are generally represented by like reference numerals for illustrative purposes throughout the figures. Understanding that these drawings depict only typical embodiments of the invention and are not therefore to be considered to be limiting of its scope, the invention will be described and explained with additional specificity and detail through the use of the accompanying drawings in which:

FIG. 1 illustrates a front perspective-view of a sliding partition fastener with a left-side latch handle in accordance with an implementation of the present invention;

FIG. 2 illustrates a rear perspective-view of a sliding partition fastener with a right-side latch handle in accordance with an implementation of the present invention;

FIG. 3 illustrates an exploded perspective-view of the interior components of the sliding partition fastener of FIG. 2;

FIG. 4A illustrates a cross-section view of the sliding partition fastener of FIG. 2 taken along the line 4A-4A of FIG. 2;

FIG. 4B illustrates a cross-section view of the sliding partition fastener of FIG. 2 similar to FIG. 4A, albeit in a locked configuration;

FIG. 5 illustrates a rear perspective-view of a sliding partition fastener having a pair of latch handles in accordance with an implementation of the present invention;

FIG. 6 illustrates a rear perspective-view of a sliding partition fastener having a latch handle and a lock in accordance with an implementation of the present invention;

FIG. 7 illustrates a rear perspective-view of a sliding partition fastener having a lock in accordance with an implementation of the present invention;

FIG. 8A illustrates a side perspective-view of the internal components of the sliding partition fastener of FIG. 6 in a released configuration;

FIG. 8B illustrates a side perspective-view of the internal components of the sliding partition fastener of FIG. 6 in a locked configuration;

FIG. 8C illustrates a side perspective-view of the internal components of the sliding partition fastener of FIG. 6 in a locked position, albeit with the lock rotated into a default position;

FIG. 8D illustrates a side perspective-view of the internal components of the sliding partition fastener of FIG. 6 in a released position with the lock rotated to a clock-wise position;

FIG. 8E illustrates a side perspective-view of the internal components of the sliding partition fastener of FIG. 6 in a released position with the lock rotated to the default position;

FIG. 9 illustrates a rear perspective-view of the sliding partition fastener of FIG. 6 positioned within a door casing;

FIG. 10 illustrates a front perspective-view of a sliding partition handle assembly that includes a sliding partition fastener in accordance with an implementation of the present invention; and

FIG. 11 illustrates a schematic view of a sliding partition including a sliding partition fastener in accordance with an implementation of the present invention.

### DETAILED DESCRIPTION OF THE PREFERRED EMBODIMENTS

Implementations of the present invention provide systems, methods, and apparatus for locking and latching sliding partitions to another structure that complement the aesthetic features of a mounted partition or set of panels. For example, one or more implementations provide compact sliding partition fasteners that can reduce the visibility of hardware by allowing the use of relatively small panel frames or other mounting hardware. In particular, one or more implementations provide compact sliding partition fasteners with a relatively small width and/or thickness.

In addition to the foregoing, various components, systems, and methods of one or more implementations can include a configurable sliding door fastener. Specifically, one or more implementations can include a sliding door fastener which a user can configure with latch handles or locks as desired. For instance, a user can selectively configure at least one sliding door fastener with a single latch handle, a pair of latch handles, a single lock, or a lock and a latch handle. Accordingly, implementations of the present invention can provide a wide range of latching options.

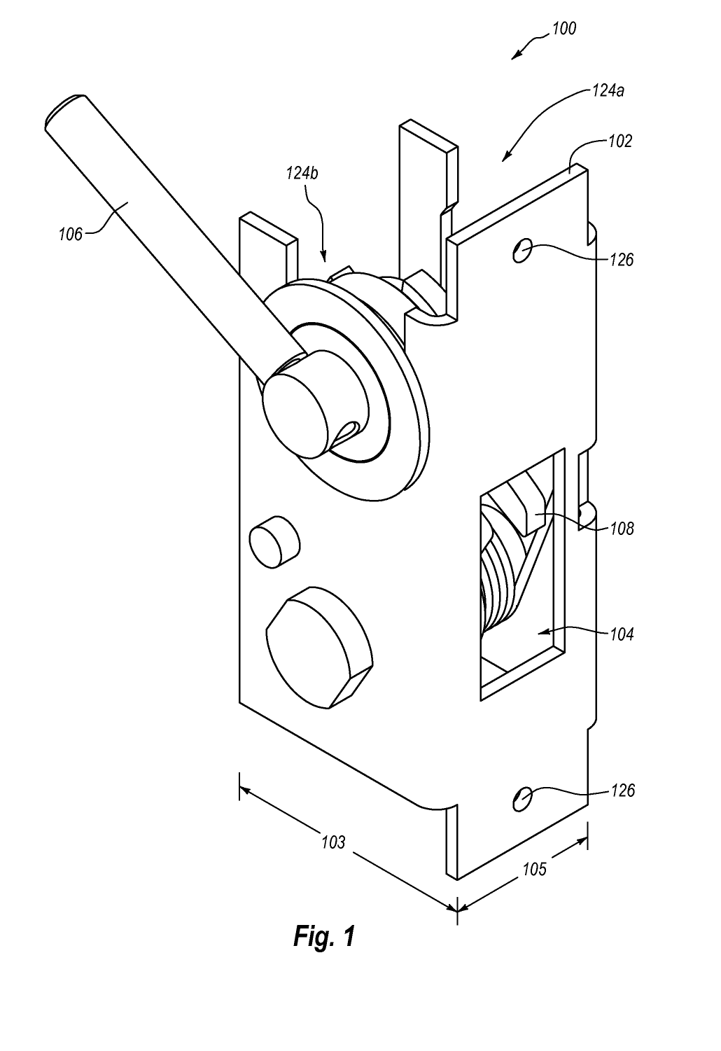

Along these lines, FIG. 1 illustrates a front perspective view of a compact, configurable sliding partition fastener 100. As shown by FIG. 1, the sliding partition fastener 100 can include a housing 102 having an opening 104 in the front thereof. The sliding partition fastener 100 can also include a latch handle 106 and a hook member 108. As explained below, a user can manipulate the latch handle 106 to move the hook member 108 between a released position within the housing 102 and a locked position, in which the hook member 108 extends out of the opening 104 of the housing 102.

FIG. 1 further illustrates that the sliding partition fastener 100 can have a width 103 and a thickness 105. The components of the sliding partition fastener 100 can have an arrangement and size to minimize the width 103 and thickness 105 of the sliding partition fastener 100. For example, in one or more implementations the sliding partition fastener 100 can have a width 103 of about 2.0 inches or less, and preferably about 1.2 inches or less. Similarly, in one or more implementations the sliding partition fastener 100 can have a thickness of about 2.0 inches or less, and preferably about 1.5 inches or less.

In addition to having a compact size, the sliding partition fastener 100 can also be configurable. More specifically, depending upon a desired use, a user can configure the sliding partition fastener 100 with various interface devices for actuating the hook member 108. For example, FIG. 1 illustrates that the housing 102 can include interface receptacles 124a, 124b. A user can secure a latch handle, a lock, or other interface device to each interface receptacle 124a, 124b. For instance, FIG. 1 illustrates the sliding partition fastener 100 includes a latch handle 106 within the interface receptacle 124b.

One will appreciate in light of the disclosure herein that the configurability of the sliding partition fastener 100 can allow a user to configure the sliding partition fastener 100 as a right-side fastener, a left-side fastener, or a dual-side fastener. For example, FIG. 1 illustrates a left-side sliding partition fastener 100. In other words, the sliding partition fastener 100 includes an interface device (i.e., latch handle 106) in the left-side interface receptacle 124b, but the right-side interface receptacle 124a is empty.

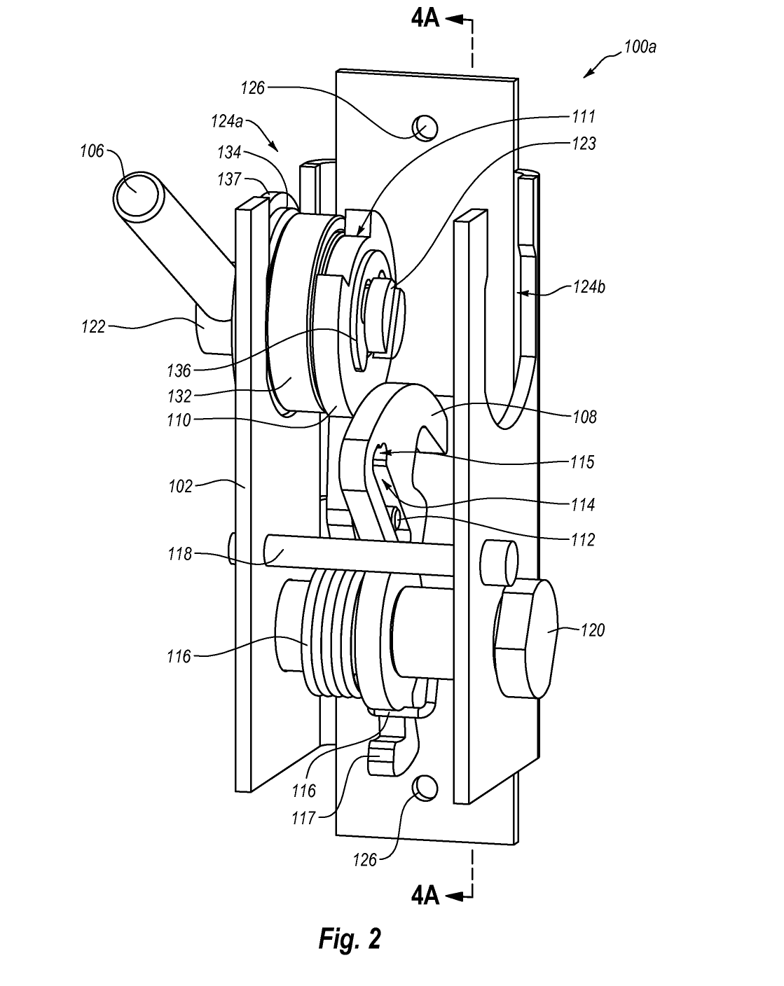

FIG. 2, on the other hand, illustrates a right-side sliding partition fastener 100a. In other words, the sliding partition fastener 100a includes an interface device (i.e., latch handle 106) in the right-side interface receptacle 124a, but the left-side interface receptacle 124b is empty. In yet further implementations, both the right-side interface receptacle 124a and the left-side interface receptacle 124a can include a latch handle, a lock, or other interface device.

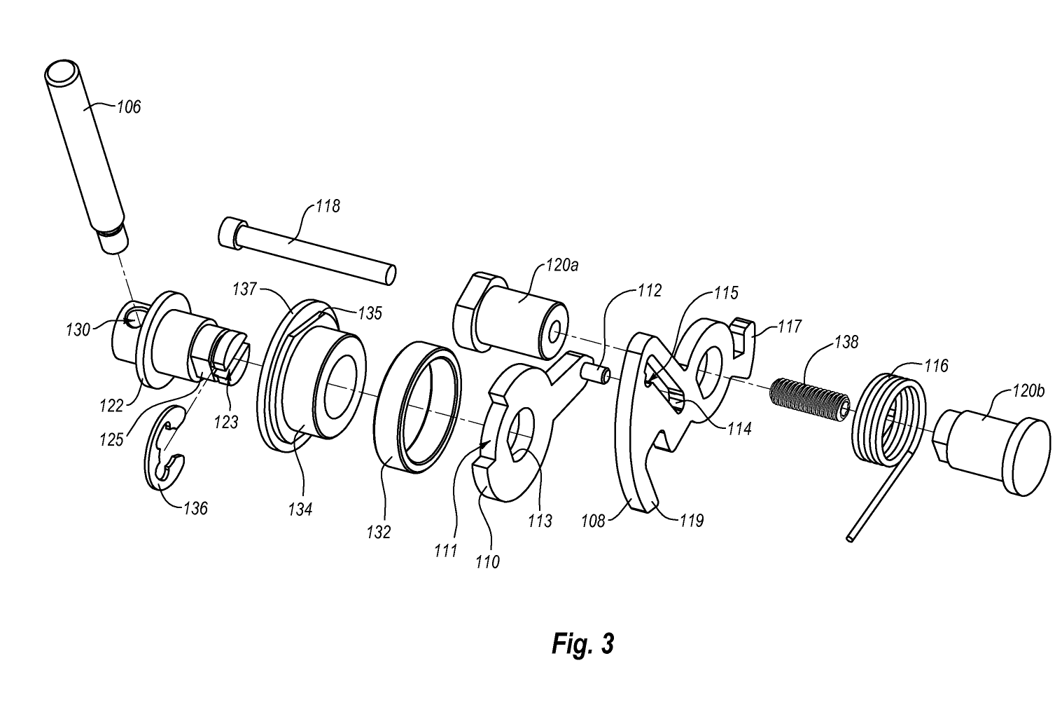

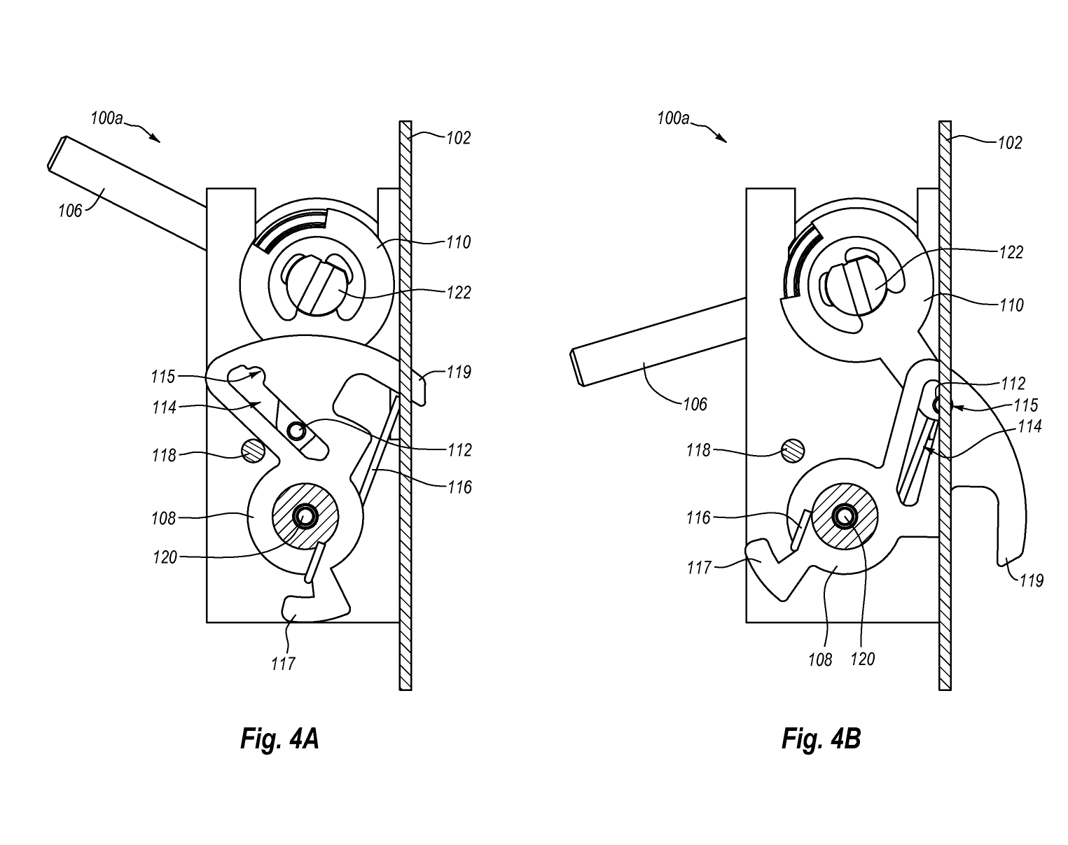

Referring now to FIGS. 2 and 3, a rear perspective-view of the right-side sliding partition fastener 100a, and an exploded perspective-view of the internal components of the right-side sliding partition fastener 100a are shown, respectively. As alluded to earlier, one or more implementations can include an actuator coupled to a hook. For example, FIG. 2 illustrates that the sliding partition fastener 100a can include an actuator 110 positioned at least partially within the housing 102. The sliding partition fastener 100a can further include a hook member 108 coupled to the actuator 110. The actuator 110 can move the hook member 108 between a released position within the housing 102 (FIG. 4A) and a locked position in which the hook member 108 is at least partially outside of the housing (FIG. 4B).

For instance, the actuator 110 can include a pin 112 that extends into a slot 114 in the hook member 108. As the actuator 110 rotates, the pin 112 can slide within the slot 114. As the pin 112 slides within the slot 114, the pin can contact the edges of the slot 114, and cause the hook member 108 to rotate in and out of the locked position. Additionally, the hook member 108 can include a locking detent 115 connected to the slot 114. The locking detent 115 can receive and secure the pin 112 when the hook member 108 is in the locked position, as explained in greater detail below.

In one or more implementations, the actuator 110 can rotate about a first axis, and the hook member 108 can rotate about a second axis that is offset from the first axis. One will appreciate in light of the disclosure herein that the offset axes of rotation can allow the sliding partition fastener 100a to have a compact configuration. For instance, the offset axes of rotation can allow the hook member 108 to have a relatively large size while still fitting within a compact housing 102.

As mentioned, the actuator 110 can rotate about a first axis. In particular, the sliding partition fastener 100a can include a first axis pin 122 configured to rotate about a first axis extending through the center thereof. The first axis pin 122 can couple the actuator 110 to the housing 102, and can cause the actuator 110 to rotate about the first axis.

For example, FIG. 2 illustrates that the first axis pin 122 can fit within an interface receptacle 124a. Specifically, in one or more implementations, a support shaft 134 can hold the first axis pin 122 within the interface receptacle 124a. The support shaft 134 can include a flange 137 and one or more planar edges 135 that mate with corresponding edges of the housing 102. The flange 137 can abut against an outer wall of the housing 102, and nut 132 can secure the support shaft 134 to the housing 102. A clip 136, in turn, can lock the first axis pin 122 within the support shaft 134.

FIGS. 2 and 3 also illustrate that the first axis pin 122 can extend through the actuator 110. The clip 136 can hold the actuator 110 to the axis pin 122. Additionally, in one or more implementations, rotation of the first axis pin 122 can cause both the first axis pin 122 and the actuator 110 to rotate about the first axis. In other words, the actuator 110 and the first axis pin 122 can have a rotatably fixed connection. For example, a flat surface 125 of the first axis pin 122 can interlock with a corresponding flat surface 113 on the actuator 110, and thus, rotatably fix the actuator 110 to the first axis pin 122.

The sliding partition fastener 100a can include one or more interface devices that a user can manipulate to cause the actuator 110 to rotate about the first axis. In one or more implementations, the sliding partition fastener 100a can include a latch handle 106 secured to the axis pin 122. For example, FIGS. 2 and 3 illustrate that the latch handle 106 can extend into a hole 130 within the axis pin 122. Thus, rotation of the latch handle 106 can cause the first axis pin 122 and the actuator 110 to rotate about the first axis.

In additional implementations, the sliding partition fastener 100a can include a second interface device, in addition to the latch handle 106. The second interface device can also allow a user to rotate the actuator 110. The sliding partition fastener 100a can include features to couple additional interface devices to the actuator 110. For example, the actuator 110 can include a groove 111 that can couple a lock to the actuator 110. Similarly, the first axis pin 122 can include a coupler 123 that can couple a second latch handle to the actuator 110.

As alluded to earlier, rotation of the actuator 110 about the first axis can cause the hook member 108 to rotate about a second axis offset from the first axis between a released position and a locked position. In particular, the sliding partition fastener 100a can include a second axis pin 120 configured to rotate about a second axis extending through the center thereof.

In one or more implementations, the second axis pin 120 can couple the hook member 108 to the housing 102. In particular, FIG. 2 illustrates that the second axis pin 120 can extend between the outer walls of the housing 102. FIG. 3 illustrates that the second axis pin 120 can include a first flanged end 120a and a second flanged end 120b coupled together by a fastener 138. FIGS. 2 and 3 also illustrate that the second axis pin 120 can extend through the hook member 108.

Thus, the hook member 108 can rotate about the second axis pin 120, and thus the second axis, between a released position and a locked position. Additionally, in one or more implementations the sliding door fastener 100a can include a biasing member adapted to bias the hook member 108 toward the released position. For example, FIGS. 2 and 3 illustrate that the sliding door fastener 100a can include a torsion spring 116. The torsion spring 116 wraps about the second axis pin 120 and engage a catch 117 of the hook member 108. The torsion spring 116 can induce counter-clockwise rotation of the hook member 108 toward the released position. Thus, the torsion spring 116 can prevent the hook member 108 from inadvertently rotating into the locked position.

Furthermore, the torsion spring 116 ensures that the hook member 108 rests in a compact position when the sliding door fastener 100a is disengaged. In alterative implementations, the biasing member may not comprise a torsion spring 116. For example, the biasing member can comprise a compression spring, a tension spring, or other device configured to bias the hook member 108 toward the released position.

FIGS. 2 and 3 further illustrate that the sliding door fastener 100a can include a stop 118. The stop 118 can extend between the walls of the housing 102. The stop 118 can prevent the biasing member 116 from causing the hook member 108 to rotate counter-clockwise out of the back or the housing 102. Thus, the stop 118 can help ensure that the sliding door fastener 100a remains compact. Furthermore, the stop 118 can provide support to the outer walls of the housing 102.

Referring now to FIGS. 4A and 4B, cross-sectional views of the sliding door fastener 100a of FIG. 2 are shown taken along the line 4A-4A of FIG. 2. FIG. 4A illustrates the sliding door fastener 100a in the released position (i.e., with the hook member 108 within the housing 102). FIG. 4B, on the other hand, illustrates the sliding door fastener 100a in the locked position (i.e., with the hook member 108 rotated out least partially out of the housing 102). In particular, as shown by FIG. 4B, when in the locked position, a hook 119 of the hook member 108 can extend outside of the housing 102 so as to be able to engage a wall, adjacent partition, or other structure.

As shown by FIGS. 4A and 4B, in order to lock the sliding door fastener 100a, a user can press downwardly on, or rotate counter-clockwise, the latch handle 106. Counter-clockwise rotation of the latch handle 106 can cause the actuator 110 to rotate in a counter-clockwise direction about the first axis. The counter-clockwise rotation of the actuator 110 can cause the pin 112 to move along the slot 114 of the hook member 108. In particular, the pin 112 can engage the sides of the slot 114, causing the hook member 108 to rotate about the second axis away from the stop 118.

As the user continues to rotate the latch handle 106 in a counter-clockwise direction, the hook member 108 can eventually rotate into the locked position shown by FIG. 4B. In particular, the hook 119 can eventually rotate out of the housing 102, as the pin 112 moves into the locking detent 115. As shown by FIG. 4B, the locking detent 115 can hold the pin 112 therein. By holding the pin, the locking detent 115 can prevent the hook 119 from inadvertently releasing, or from being released by manipulation of the hook 119.

In particular, the position of the locking detent 115 relative to the actuator 110 can ensure any counter-clockwise rotation of the hook member 108 creates forces on the pin 112 directed straight toward the first axis (i.e., the center of the axis pin 122) or in a counter-clockwise direction. In some implementations, such forces will fail to rotate the actuator 110 in a clockwise direction, and thus, fail to release the pin 112 from the locking detent 115. Thus, when in the locked position, the locking detent 115 and pin 112 can prevent the unlocking of the sliding door fastener 100a by manipulation of the hook 119. In other words, in one or more implementations, once in the locked position, lifting the hook 119 using a credit card or other mechanism will fail to release the hook 119.

Furthermore, when in the locked position, the spring 116 can bias the hook member 108 to rotate in a counter-clockwise direction. This counter-clockwise moment acting on the hook member 108 can force the locking detent 115 against the pin 112, and thus, maintain the sliding door fastener 100a in the locked position. As such, in one or more implementations, the pin 112 and locking detent 115 can prevent the hook 119 from being released without using the latch handle 106 or other interface device to rotate the actuator 110 in a clockwise direction.

To unlock or unlatch the sliding door fastener 100a and return the hook 119 to the unlocked position, the user can lift up on, or rotate clockwise, the latch handle 106. Clockwise rotation of the latch handle 106 can cause the actuator 110 to rotate clockwise about the first axis. The clockwise rotation of the actuator 110, in turn, can cause the pin 112 to move out of the locking detent 115 into the slot 114. Once the pin 112 is released from the locking detent 115, the biasing force created by the spring 116 can automatically rotate to hook 119 into the released position. Thus, in one or more implementations, a user need only slightly turn the latch handle 106, or other interface device, to unlock the sliding door fastener 100a.

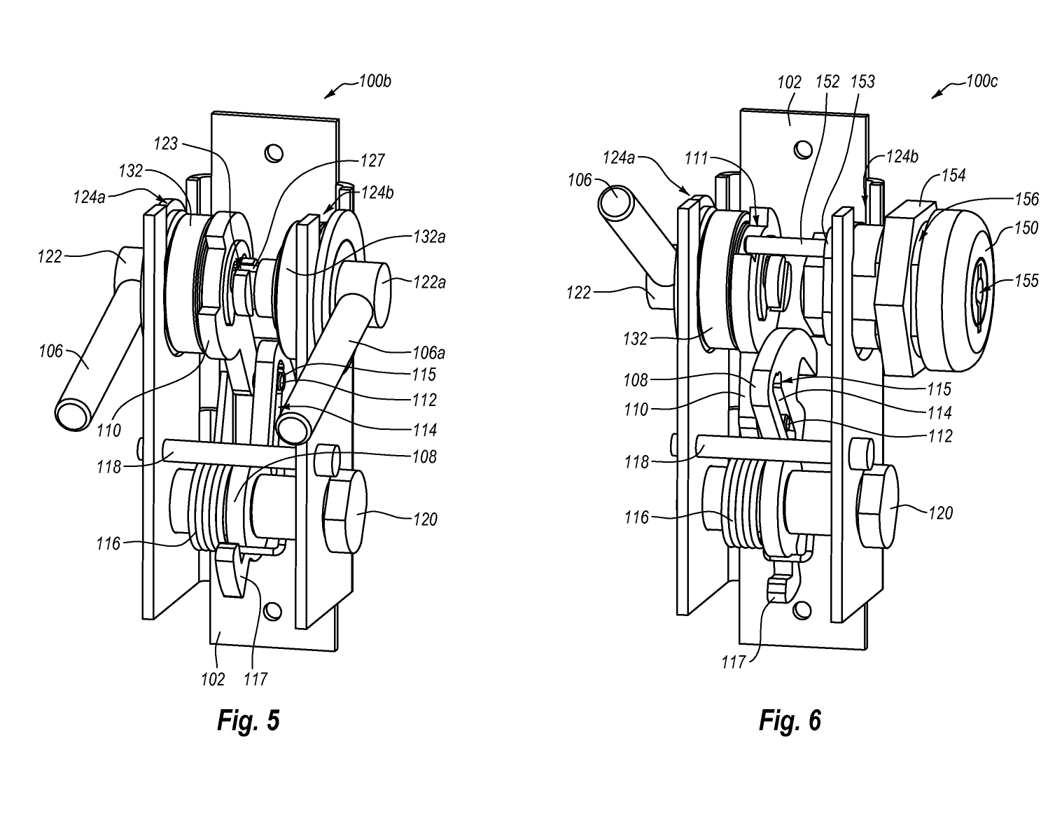

As previously mentioned, one or more implementations of the present invention can include configurable sliding partition fasteners. More specifically, depending upon a desired use, a user can configure the sliding partition fastener 100 with various interface devices for actuating the hook member 108. For example, FIG. 5 illustrates a sliding partition fastener 100b including two latch handles 106, 106a in accordance with an implementation of the present invention.

In particular, FIG. 5 illustrates that the sliding partition fastener 100b can include the same parts and components shown and described herein above in relation to the sliding partition fastener 100a of FIGS. 2, 3, and 4A-4B. Additionally, FIG. 5 illustrates that the sliding partition fastener 100b can include complementary axis pin 122a secured within the left-side interface receptacle 124b via a fastener (i.e., nut 132a). The complementary axis pin 122a can hold a second latch handle 106a, which a user can manipulate to move the hook member 108 and associated hook 119 in and out of the locked position.

More specifically, the coupler 123 of the first axis pin 122 can mate with a corresponding coupler 127 on the end of the complementary axis pin 122a. For example, FIG. 5 illustrates that the coupler 123 can comprise a slot, and the corresponding coupler 127 can comprise a rib inserted into the slot 123. The mating configuration of the first axis pin 122 and the complementary axis pin 122a can cause the first and second latch handles 106, 106a to turn or rotate simultaneously. Thus, a user can manipulate either the first latch handle 106 or the second latch handle 106a in order to move the hook member 108 between the released position (FIG. 4A) and the locked position (FIG. 4B).

As previously mentioned, one or more implementations can allow a user to configure a sliding partition fastener with various interface devices configured to rotate the actuator 110. One will appreciate in light of the disclosure herein that such interface devices can include devices other than latch handles 106, 106a. For example, FIG. 6 illustrates a sliding partition fastener 100c including a lock 150 and a latch handle 106.

In particular, FIG. 6 illustrates that the sliding partition fastener 100c can include the same parts and components shown and described herein above in relation to the sliding partition fastener 100a of FIGS. 2, 3, and 4A-4B. Additionally, FIG. 6 illustrates that the sliding partition fastener 100c can include a lock 150 secured within the left-side interface receptacle 124b. The lock 150 can include a dowel pin 152 extending from the lock 150 into the groove 111 of the actuator 110. In one or more implementations, the dowel pin 152 is offset from the first axis of rotation (i.e., the center of axis pin 122). The dowel pin 152 can allow a user to manipulate the lock 150 to move the hook 119 in and out of the locked position.

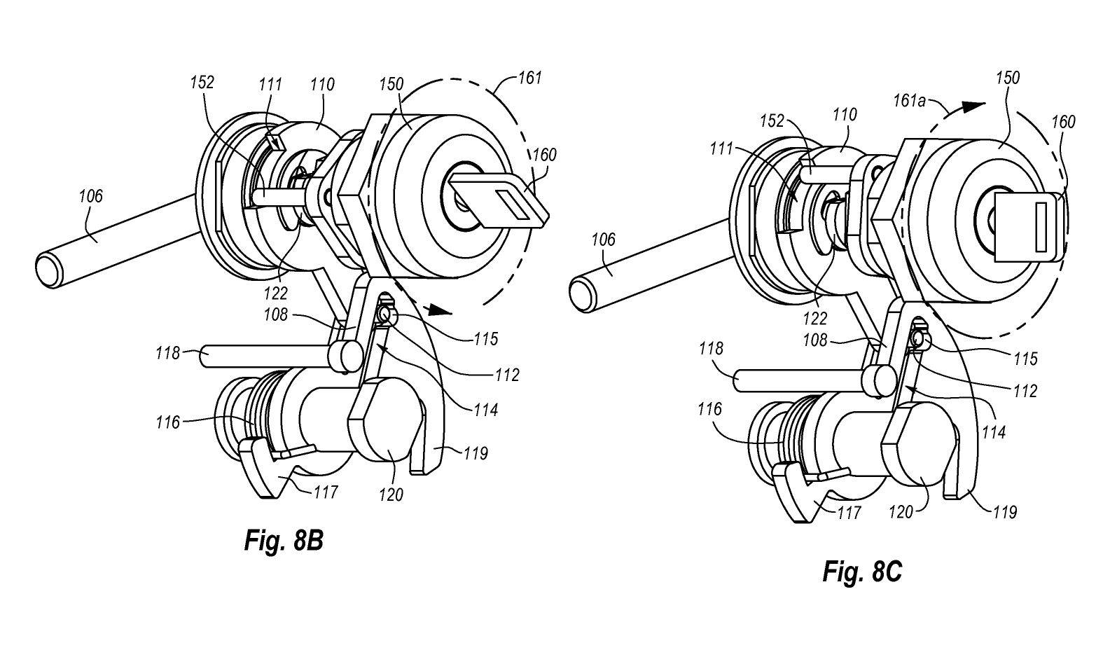

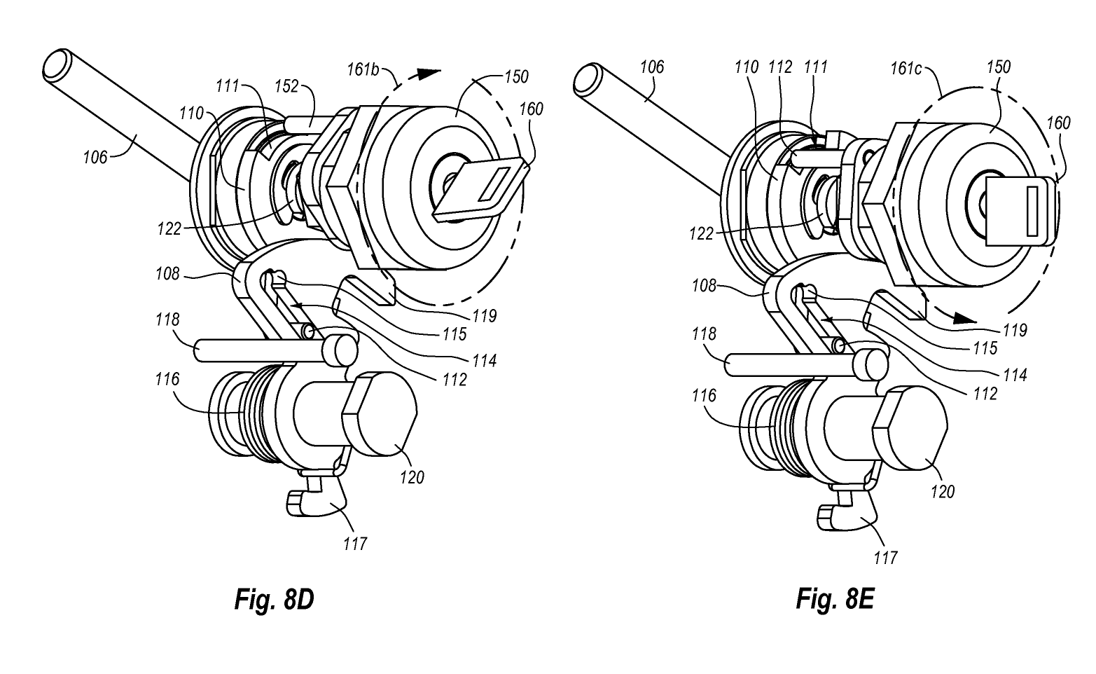

The lock 150 can comprise any number of different configurations. For example, FIG. 6 illustrates that in one or more implementations the lock 150 can comprise a cam lock that requires a key or other device to turn. Specifically, FIG. 6 illustrates that the lock 150 can include a key hole 155. The key hole 155 can receive a corresponding key 160 (FIGS. 8B-8E). Thus, the key hole 155 can ensure that only a user with the proper key can engage or disengage the sliding partition fastener 100c.

Additionally, in one or more implementations, the lock 150 can include one or more features that allow a user to secure the lock 150 to a partition frame or casing. For example, FIG. 6 illustrates that the lock 150 can include a channel 156, within which a user can place a wall of the casing. Furthermore, the lock 150 can include a locking nut 154, which a user can use to secure the lock 150 to the casing.

As explained in greater detail below, a user can turn a key within the key hole 155 to cause the dowel pin 152 to rotate about the first axis. As the dowel pin 152 rotates about the first axis, the dowel pin 152 can engage the sides of the groove 111 of the actuator 110, and cause the actuator 110 to also rotate about the first axis. As described herein above, rotation of the actuator 110 about the first axis can cause the pin 112 to move within the slot 114 of the hook member 108. The movement of the pin 112, in turn, can cause the hook member 108, and the associate hook 119, to rotate between the released position and the locked position.

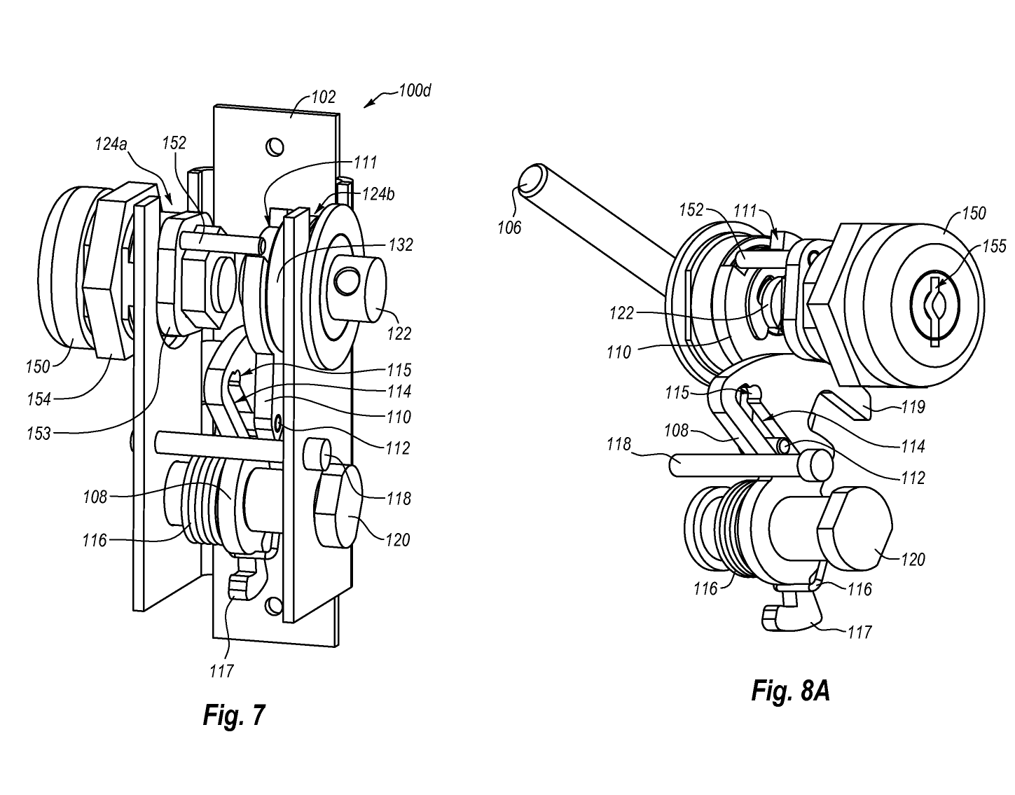

FIG. 7 illustrates yet an additional configurable sliding partition fastener 100d in accordance with one or more implementations. As shown in FIG. 7, the sliding partition fastener 100d can include a single interface device. In particular, the sliding partition fastener 100d can include a lock 150 positioned within the right-side interface receptacle 124a. The sliding partition fastener 100d can further include the same parts and components shown and described herein above in relation to the sliding partition fastener 100a of FIGS. 2, 3, and 4A-4B. As shown in FIG. 7, however, the first axis pin 122 may reside within the left-side interface receptacle 124b instead of the right-side interface receptacle 124a.

Similar to the sliding partition fastener 100c of FIG. 6, a user can manipulate a key to turn the lock 150. The lock 150, in turn, can rotate the dowel pin 152 about the first axis. As the dowel pin 152 rotates about the first axis, the dowel pin 152 can engage the sides of the groove 111 of the actuator 110, causing the actuator 110 to rotate about the first axis. Rotation of the actuator 110, in turn, can cause the pin 112 to slide within the slot 114 of the hook member 108, which can cause the hook member 108 and associate hook 119 to rotate about the second axis between the released and locked positions.

As FIGS. 2 and 5-7 illustrate, a user can configure the sliding partition fasteners of one or more implementations in a wide variety of configurations to provide a wide variety of functionality. For example, a user can configure each side of a sliding partition fastener with a latch handle 106, a lock 150, another interface device, or no interface device. Thus, one or more implementations can allow for sliding door fasteners having a single latch handle, a pair of latch handles, a latch handle and a lock, or just a lock. Furthermore, one or more implementations can allow a user to selectively choose which side to place the interface devices. Thus, one or more implementations can allow a user to configure a right-side fastener, a left-side fastener, or a dual-side fastener.

Accordingly, the user can configure a sliding partition fastener as needed for a particular design environment. For instance, if used with an external door, the user can configure the sliding partition fastener with a lock 150 and a latch handle 106, such as sliding partition fastener 100c of FIG. 6. On the other hand, if used with a closet door, the user can configure the sliding partition fastener with just a lock 150 or just a latch handle 106, such as sliding partition fasteners 100 of FIGS. 2 and 100d of FIG. 7, respectively. Alternatively, if used with an internal door or moveable room divider, the user can configure the sliding partition fastener with a two latch handles 106, 106a, such as sliding partition fastener 100b of FIG. 5. In any event, implementations of the present invention can provide a user with a wide range of latching options.

Referring now to FIGS. 8A-8E, perspective views of the internal components of the sliding partition fastener 100c of FIG. 6 are shown. In particular, FIGS. 8A-8E illustrate how a user can use either the lock 150 or latch handle 106 to selectively rotate the hook 119 between the released position and the locked position. As explained in greater detail below, the groove 111 of the actuator 110 can allow a user to use the latch handle 106 to unlock the hook 119 irrespective of whether the hook was rotated into the locked position using the lock 150 or the latch handle 106. Similarly, the groove 111 of the actuator 110 can allow a user to unlock the hook 119 irrespective of whether the hook was rotated into the locked position using the lock 150 or the latch handle 106.

Referring now to FIG. 8A, the internal components of the sliding door fastener 100c are illustrated in the released position. FIG. 8A also illustrates the key hole 155 of the lock 150 aligned in a default, vertical position. When the key hole 155 is aligned in the default position, the lock 150 can allow a user to insert a key therein, or withdraw a key therefrom.

As shown by FIG. 8B in order to lock the sliding door fastener 100c, a user can insert a key 160 in the key hole 155 and rotate the lock 150 counter clockwise as indicated by arrow 161. The counter-clockwise rotation of the lock 150 can cause the dowel pin 152 to engage the edges of the groove 111, which can cause the actuator 111 to rotate counter-clockwise about the first axis. The counter-clockwise rotation of the actuator 110 can cause the pin 112 to move along the slot 114 of the hook member 108. In particular, the pin 112 can engage the sides of the slot 114, causing the hook member 108 to rotate about the second axis away from the stop 118.

As the user continues to rotate the key 160 in a counter-clockwise direction, the hook member 108 can eventually rotate into the locked position as shown by FIG. 8B. In particular, the hook 119 can eventually rotate out of the housing 102 (FIG. 6), as the pin 112 moves into the locking detent 115. As shown by FIG. 8B, and as explained in greater detail above, the locking detent 115 can hold the pin 112 therein. In particular, the locking detent 115, spring 116, and over-centered angle of the actuator 110 relative to the hook 119 can prevent the pin 112 from being inadvertently released the locking detent 115, or being released by manipulation of the hook 119.

Once in the locked position, the user can use the key 160 to rotate the lock 150 clockwise, as shown by arrow 161a of FIG. 8C, to return the key hole 155 to the default position. At this point, the user can withdraw the key 160 from the key hole 155. Once in the locked position with the key 160 removed, the sliding partition fastener 100c can prevent unlocking of the hook 119 from the lock 150 side of the slidable partition fastener.

As shown in the Figures, the groove 111 of the actuator 110 can extend a length circumferentially about the first axis. This configuration of the groove 111 can allow the latch handle 106, first axis pin 122, and the actuator 110 to rotate independent of the dowel pin 152 and lock 150. Thus, once in the locked configuration shown in FIG. 8C, a user can lift up on, or rotate clockwise, the latch handle 106 to unlock the hook 119. The clockwise rotation of the actuator 110 can cause the pin 112 to move out of the locking detent 115 into the slot 114. Once the pin 112 is released from the locking detent 115, the biasing force created by the spring 116 can cause the hook member 108 to rotate back to the released position shown in FIG. 8A.

Thus, as shown by FIGS. 8A and 8B, the groove 111 of the actuator 110 can allow the actuator 110 to rotate about the first axis between the locked and released positions without moving the dowel pin 152. One will appreciate in light of the disclosure herein, that this configuration can allow a user to manipulate the latch handle 106 to rotate the actuator 110, hook member 108, and hook 119 in and out of the locked position independent of the movement of the lock 150. Thus, in one or more implementations, the components of the sliding partition fastener 100c can prevent a person from being locked inside a room.

Referring now to FIGS. 8D and 8E, a user can use the lock 150 to unlock the hook 119 irrespective of whether the sliding partition fastener 100c was locked using the latch handle 106 or lock 150. In particular, as shown by FIG. 8D, in order to unlock the sliding door fastener 100c, a user can insert a key 160 in the key hole 155 and rotate the lock 150 clockwise as indicated by arrow 161b. Clockwise rotation of the lock 150 can cause the dowel pin 152 to engage the edges of the groove 111, which can cause the actuator 111 to rotate clockwise about the first axis. The clockwise rotation of the actuator 110 can cause the pin 112 to move out of the locking detent 115 and into the slot 114.

At this point the spring 116, or further rotation of the lock 150, can cause the hook 119 to rotate from the locked position (FIG. 8C) to the released position (FIG. 8D). Specifically, the hook 119 can rotate into the housing 102 (FIG. 6) and against the stop 118. Once in the released position, the user can use the key 160 to rotate the lock 150 in a counter-clockwise direction, as shown by arrow 161c of FIG. 8E, to return the key hole 155 to the default position. At this point, the user can withdraw the key 160 from the key hole 155.

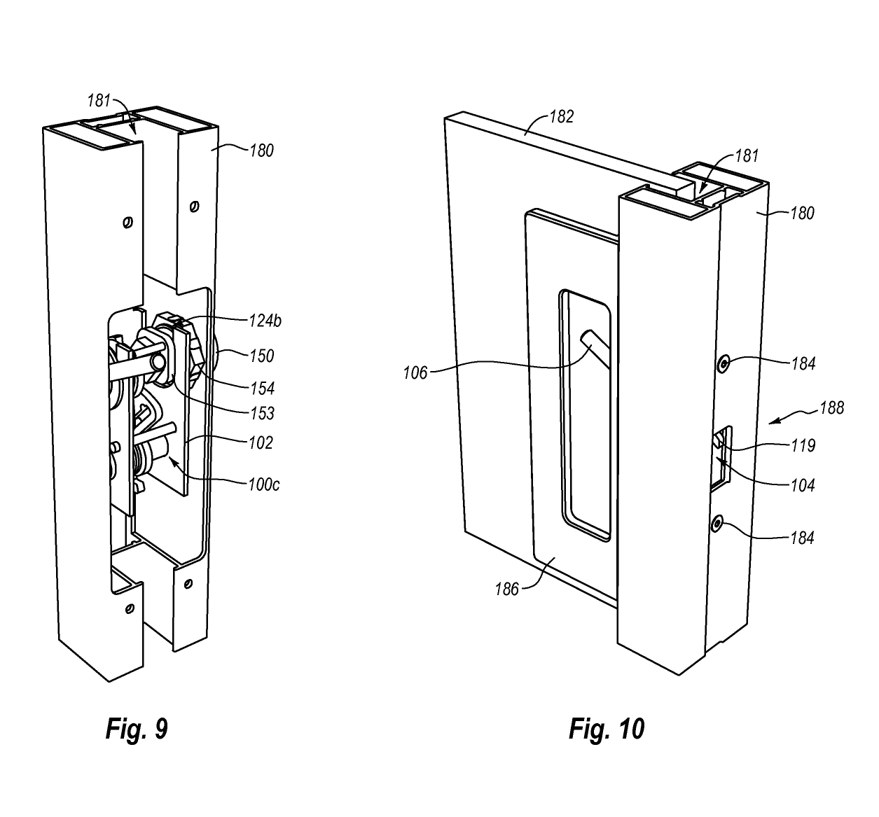

As alluded to above, one or more sliding partition fasteners of the present invention can have a compact configuration allowing a user to mount the sliding partition fastener within a relatively small door casing or frame. For example, FIG. 9 illustrates a rear perspective view of the sliding partition fastener 100c of FIG. 6 mounted within a door casing 180. As shown by FIG. 9, the door casing 180 can conceal the sliding partition fastener 100c from view.

In particular, FIG. 9 illustrates that the lock 150 can extend through a hole in the door casing 180. The locking nut 154 can secure or hold the lock 150 within the hole of the door casing 180. Additionally, a pair of screws 184 (FIG. 10) or other fastening devices can extend through mounting holes 126 (FIG. 1) of the housing 102, and secure the housing 102 to the casing 180.

In addition to sliding partition fasteners, one or more implementations of the present invention can also include door handle assemblies. For example, FIG. 10 illustrates a perspective view of a door handle assembly 188. The door handle assembly 188 can include a sliding partition fastener and a door handle 186. A user can secure the door handle assembly 188 to a door casing 180, which can also hold a partition or panel 182 within a mounting channel 181.

The door handle 186 can allow a user to slide the panel 102 between an open and closed configuration. The sliding partition fastener can allow the user to lock the panel 102 to another structure. In particular, the user can manipulate a latch handle 106, or other interface device, to cause a hook 119 to move from a released position within the door casing 180, out of an opening 104 in the housing 102 (FIG. 1), and into a corresponding latch on another structure.

One will appreciate in light of the disclosure herein that the components of the sliding partition fastener, door casing, and door handle assembly comprise a strong, light-weight material. For instance, according to at least one implementation, these components can each comprise a metal or alloy thereof, such as for example, aluminum or stainless steel. One will appreciate, however, that these and other components described herein can be prepared from any number of metallic materials, synthetic or naturally occurring resins, rubbers, glass, and/or composites thereof.

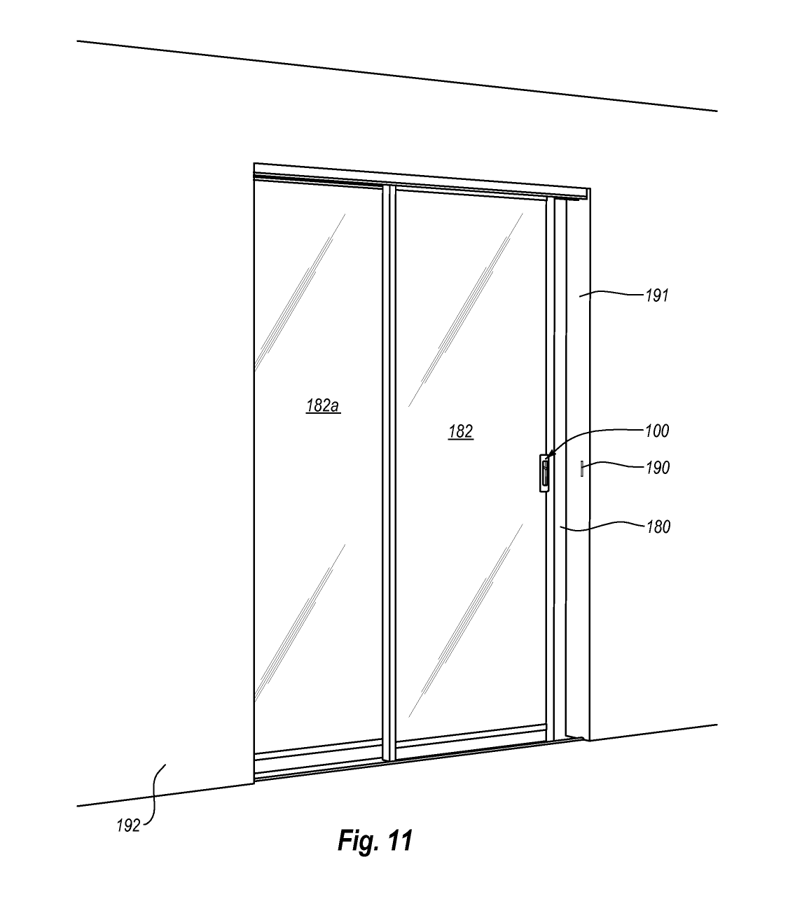

As mentioned previously, one or more sliding partition fasteners of the present invention can allow a user lock or latch a sliding partition to another structure. For example, FIG. 11 illustrates a sliding partition including a pair of decorative architectural panels 182, 182a that function as bypassing doors. The panels 182, 182a are mounted within a wall 192 and allow access to spaces divided by the wall 192.

The sliding partition can further include a door casing 180 secured to the panel 182. The door casing 180 can hold a compact, sliding partition fastener 100 therein. The sliding partition fastener 100 can allow a user to secure the panel 182 to latch 190 within a support structure (i.e., door frame 191).

In particular, a user can slide the panel 182 against the door frame 191. At this point, the user can manipulate an interface device (i.e., latch handle 106 or lock 150) to cause a hook 119 to rotate out of the door casing 180, as explained in greater detail above. As the hook 119 rotates out of the door casing 180, the hook 119 can engage the latch 190. The hook 119 can lock or hold the panel 182 against the door frame 191. As desired, the user can manipulate an interface device (i.e., latch handle 106 or lock 150) to cause a hook 119 to disengage the latch 190 and rotate back into the door casing 180. When the sliding door fastener 100 is disengaged, the user can freely slide the panel 182 to open the sliding partition.

Implementations of the present invention can also include methods of assembling a sliding door fastener and mounting the sliding door fastener within a door casing. The following describes at least one implementation of a method of assembling a sliding door fastener and mounting the sliding door fastener within a door casing with reference to the components and diagrams of FIGS. 1 through 11. Of course, as a preliminary matter, one of ordinary skill in the art will recognize that the methods explained in detail herein can be modified to install a wide variety of configurations using one or more components of the present invention. For example, various acts of the method described can be omitted or expanded, and the order of the various acts of the method described can be altered as desired.

Thus, according to one method of the present invention, the method can include an act of securing an actuator to a housing. For example, a user can secure a first axis pin 122 within an interface receptacle 124a, 124b of the housing 102 using a support shaft 134 and a nut 132. After which, or even before if desired, the user can secure the actuator 110 to the first axis pin 122. Specifically, the user can insert the first axis pin 122 at least partially through a hole in the actuator 110. In so doing the user can align a flat surface 125 of the first axis pin 122 with a corresponding flat surface 113 on the actuator 110, and thereby, rotatably fix the actuator 110 to the first axis pin 122. The user can then lock the actuator 110 to the first axis pin 122 using a clip 136.

The method can also include an act of securing one or more interface devices to the actuator. For instance, the user can insert a latch handle 106 within a hole 130 of the first axis pin 122. Alternatively or additionally, the user can secure a lock 150 to the actuator 110. In particular, the user can insert the lock 150 into a second interface receptacle 124a, 124b. The user can then insert a dowel pin 152 of the lock 150 into a groove 111 of the actuator 110.

In yet further implementations, the user can secure a second latch handle 106a to the actuator 110. Specifically, the user can secure a complementary axis pin 122a within a second interface receptacle 124b via a fastening device (i.e., nut 132a). The user can then couple the complementary axis pin 122a to the first axis pin 122. For example, the user can insert a rib 127 of the complementary axis pin 122a into a slot 123 of the first axis pin 122. Thereafter, or before if desired, the user can then secure the second latch handle 106a to the complementary axis pin 122a.

Additionally, the method can include an act of securing a hook member to the actuator. For instance, the user can insert a pin 112 extending from the actuator 110 into a slot 114 formed in the hook member 108. The user can then secure the hook member 108 to the housing 102 via a second axis pin 120.

Furthermore, in one or more implementations, the method can include an act of securing the sliding partition fastener to a door casing. For example, the user can insert the sliding partition fastener 100, 100a-d into the door casing 180. The user can then secure the housing 102 to the door casing 180 using one or more screws 184. Optionally, the user can first secure a lock 150 within a hole in the door casing 180 using a nut 154. The user can then slide the sliding partition fastener 100, 100a-d into the door casing 180. In particular, the user can slide an interface receptacle 124a, 124b about the body of the lock 150.

Accordingly, FIGS. 1-11 and the corresponding text, therefore, specifically show, describe, or otherwise provide a number of systems, components, apparatus, and methods for efficiently fastening a sliding partition to another structure. Additionally, at least one implementation of the present invention includes systems, components, apparatus that provide a user with a wide variety of configuration options. Furthermore, one or more implementations of the present invention can lock or latch sliding partitions using compact hardware that allows for the user of smaller, less noticeable hardware.

The present invention may be embodied in other specific forms without departing from its spirit or essential characteristics. For example, the sliding partition fasteners of the present invention have been described primarily with reference to use with sliding doors. One will appreciate, however, that sliding door panels, particularly resin-based panels, are only one type of “structure” which a user can fasten to another structure using the components, systems, and methods described herein.

For example, a user can use implementations of the present invention to fasten not only door panels but windows, room partitions, wall coverings, and other structures. Along similar lines, one or more implementations can secure not only resin panels, as such, but also glass panels, to a given support structure. Furthermore, one will appreciate that a user can use various components and assemblies described herein to fasten other types of structures having different material compositions, such as objects comprising wood, stone, fiberglass, or the like, which may or may not exhibit primarily panel-like dimensions as described herein. Reference herein, therefore, to panels, or even resin panels, as such, is primarily for convenience in description.

Thus, the described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

I claim:

1. A fastener configured to latch a first object, such as a sliding partition, to a second object, such as a wall or a second partition, comprising:
a housing;
an actuator positioned at least partially within the housing, the actuator being configured to rotate about a first axis; and
a hook coupled to the actuator, the hook being configured to rotate about a second axis that is offset from the first axis;
wherein rotation of the actuator about the first axis causes the hook to rotate about the second axis between a released position and a locked position.

2. The fastener as recited in claim 1, further comprising:
a slot within the hook; and
a pin extending from the actuator into the slot of the hook.

3. The fastener as recited in claim 2, wherein rotation of the actuator causes the pin to slide along the slot thereby causing the hook to rotate between the released position and the locked position.

4. The fastener as recited in claim 2, further comprising a locking detent connected to the slot, the locking detent being configured to receive and secure the pin therein.

5. The fastener as recited in claim 4, wherein the locking detent is positioned relative to the actuator so that the when the hook is in the locked position, the pin is prevented from being released from the locking detent by manipulation of the hook.

6. The fastener as recited in claim 1, further comprising a biasing member configured to bias the hook toward the released position.

7. The fastener as recited in claim 1, further comprising a latch handle configured to rotate the actuator.

8. The fastener as recited in claim 7, further comprising a second latch handle configured to rotate the actuator.

9. The fastener as recited in claim 8, wherein latch handle is coupled to the second latch handle so that rotation of one of the latch handle and the second latch handle causes the other of the latch handle and the second latch handle to rotate.

10. The fastener as recited in claim 1, further comprising a lock configured to rotate the actuator.

11. The fastener as recited in claim 1, wherein the fastener has a width of approximately 1.2 inches or less when the hook is in the released position.

12. A compact fastener configured to latch a first object, such as a sliding partition, to a second object, such as a wall or second partition, comprising:
a hook;
an actuator coupled to the hook, the actuator including a groove therein;
a lock configured to receive a key and rotate about a first axis; and
a dowel pin secured to the lock, the dowel pin extending from the lock into the groove of the actuator;
wherein rotation of the lock about the first axis causes the dowel pin to engage the groove of the actuator and rotate the actuator, thereby causing the hook to move between a locked position and a released position.

13. The compact fastener as recited in claim 12, further comprising a latch handle coupled to the actuator, the latch handle being configured to rotate the actuator and cause the hook to move between the locked position and the released position.

14. The compact fastener as recited in claim 13, wherein the groove of the actuator is configured to allow the latch handle to rotate the actuator and cause the hook to move between the locked position and the released position independent of the movement of the dowel pin and the lock.

15. The compact fastener as recited in claim 12, further comprising:
a slot within the hook; and
a pin extending from the actuator into the slot of the hook;
wherein rotation of the actuator causes the pin to slide along the slot and rotate the hook.

16. The compact fastener as recited in claim 15, further comprising a locking detent connected to the slot, the locking detent being configured to receive the pin and hold the hook in the locked position.

17. A sliding partition, comprising:
a decorative architectural panel;
a casing secured to at least one edge of the decorative architectural panel;
a sliding partition fastener at least partially enclosed with the casing, the sliding partition fastener being configured to latch the decorative architectural panel to another structure, the sliding partition fastener comprising:
an actuator configured to be rotated by one or more of a latch handle and a lock;
a hook coupled to the actuator, the hook comprising a slot; and
a pin extending from the actuator into the slot of the hook;
wherein rotation of one or more of the latch handle and the lock cause the pin to slide along the slot and rotate the hook in and out of a locked position.

18. The sliding partition in claim 17, further comprising a door handle secured to the casing about the sliding partition fastener.

19. The sliding partition as recited in claim 17, wherein the decorative architectural panel comprises a resin-based panel.

20. The sliding partition as recited in claim 17, further comprising a dowel pin extending from the lock into a groove formed in the actuator, the dowel pin being configured to rotate the actuator as the lock is rotated.
